(19) United States
(12) Patent Application Publication
(10) Pub. No.: US 2022/0401195 A1
(43) Pub. Date: Dec. 22, 2022

(54) ARTIFICIAL TOOTH ELEMENT

(71) Applicant: VITA ZAHNFABRIK H. RAUTER GMBH & CO., KG, Bad Säckingen (DE)

(72) Inventors: Eva Kolb, Bad Säckingen (DE); Stefan Aechtner, Bad Säckingen (DE); Garrit Hansen, Bad Säckingen (DE)

(73) Assignee: VITA ZAHNFABRIK H. RAUTER GMBH & CO. KG, Bad Säckingen (DE)

(21) Appl. No.: 17/772,030

(22) PCT Filed: Oct. 20, 2020
(86) PCT No.: PCT/EP2020/079498

§ 371 Date: Apr. 26, 2022

(30) Foreign Application Priority Data
Oct. 29, 2019 (EP) 19205897.2

(51) Int. Cl. A61C 13/093; A61C 13/01; A61C 13/08

(52) U.S. Cl. CPC A61C 13/1006; A61C 13/01; A61C 13/08

(57) ABSTRACT

An artificial tooth element which is insertable into a cavity of a prosthesis base and has an outer part and an inner part. The outer part is the part of the artificial tooth element which is visible in the inserted state. Consequently, the inner part is the part of the artificial tooth element which is not visible in the inserted state. The inner part has a surface which has, at least partially, in particular completely, a defined surface roughness.

### BACKGROUND

### 1. Field of the Disclosure

The disclosure relates to an artificial tooth element, as well as to a prosthesis comprising a prosthesis base and artificial tooth elements.

### 2. Discussion of the Background Art

With known prefabricated artificial teeth, it is necessary that these are shortened at the base side by an orthodontist and that the surface is roughened. Shortening is necessary in order to adapt the basal inner part of the tooth element, i.e. the part of the tooth element that is inserted into the prosthesis cavity and is invisible in the inserted state, to the cavity provided in the prosthesis base. Roughening is required in order to achieve sufficient strength and stability after the fastening, in particular after the insertion and gluing of the tooth element into the prosthesis base. The shortening and roughing of the inner part of the tooth element by an orthodontist has the disadvantage that the accuracy always depends on the manual skills of the orthodontist and thus results may possibly be obtained that vary largely in quality. Further, such a shortening and roughening of the artificial tooth element by the orthodontist also entails considerable costs.

It is an object of the disclosure to provide an artificial tooth element in which working on the inner part by an orthodontist is not required or is required to only a limited extent.

### SUMMARY

The artificial tooth element of the present disclosure has an outer part and an inner part. The outer part is the part of the tooth element that is visible in the inserted state, i.e. when the tooth element is inserted into a cavity of a prosthesis base. Consequently, the inner part of the tooth element is the part that is not visible in the inserted state. Regardless of the insertion state, the outer part and the inner part are also defined by the virtual gingiva line. The part of the tooth element, which is the basal part with respect to the virtual gingiva line, is the inner part, and the part which is incisal/occlusal with respect to the virtual gingiva line, is the outer part of the tooth element. The virtual gingiva line, which preferably defines the dividing line between the inner part and the outer part, is preferably circumferential throughout.

According to the disclosure at least parts, in particular all of the surface of the inner part of the artificial tooth element has a defined surface roughness. Thus, the roughness of the surface is created by the manufacturer. As such, the artificial tooth element has a defined surface roughness ex works. Therefore, a reworking of the surface of the inner part by an orthodontist is generally no longer required. Rather, such an artificial tooth element of the present disclosure can be used directly, i.e. fastened, i.e. in particular inserted and glued, in the corresponding cavity of the prosthesis basis.

The virtual gingiva line varies among patients in particular in dependence on the age of a patient. As such, the virtual gingiva line is well suited to define the inner part, which is relevant to the disclosure, and the outer part of the tooth element. Here, it is preferred that the artificial tooth element is roughened or has a defined surface roughness in a region that extends slightly beyond the virtual gingiva line towards the outer part. Thereby, it is ensured that the surface that is relevant to the fastening, i.e. in particular the insertion and the gluing of the artificial tooth element into the cavity, has the necessary roughness. The fact that a small portion of the outer part is also roughened is of no particular importance, since the artificial tooth element will have to be worked, in particular polished, anyway after fastening. This is necessary, e.g., to remove residual adhesive. Thus, it is advantageous that the defines surface roughness is provided on a surface slightly larger than the inner part so as to ensure safe bonding.

The surface having the defined surface roughness is preferably at least the size of the bonding surface and is preferably slightly larger. Preferably, the bonding surface extends slightly beyond the virtual gingiva line into the outer part. Here, a protrusion of 0.5 to 1 mm may exist.

In a particularly preferred embodiment of the artificial tooth element, the surface roughness has an average roughness value Rₐ of >0 to 30 μm. An average roughness value Rₐ of >0 to 10 μm, particularly 0.5 to 5 μm, is preferred, with 1 to 4 μm being particularly preferred, and 2 to 3 μm being more preferred.

The average roughness value Rₐ is determined by:
Method: profile-based stylus instrument procedure
Measuring instrument: HOMMEL-ETAMIC TURBO WAVE V7.62
Measuring stylus: TKU100
Measuring distance: 7.5 μm
Measuring speed vₜ: 0.15 mm/s

The roughness depth R_{c} is preferably in a range of 5 to 25 μm, in particular 5 to 20 μm.

In particular, the lower limit of the arithmetic average roughness value Rₐ is at least 0.6 μm, preferably at least 0.8 μm and particularly preferred at least 1 μm. Regardless of the lower limit of the arithmetic average roughness value, it is preferred that, as described above, an upper limit is ≤10 μm, in particular ≤5 μm, in particular ≤4 μm, and particularly preferred ≤3 μm.

The visible outer part is preferably smoother than the inner part of the artificial tooth element of the present disclosure. Preferably, the arithmetic average roughness value Rₐ of the inner side is greater than the arithmetic average roughness value Rₐ of the outer side. In particular, this value is 30% higher and, as is particularly preferred, 50% higher, so that the inner part is significantly rougher than the outer part.

In a preferred development of the artificial tooth element of the present disclosure, the inner part has a minimum outer radius of at least 0.6 mm. The smallest radius present in the region of the inner part is thus 0.6 mm or more. This is particularly advantageous for forming a cavity in a prosthesis base. It is particularly preferred that the maximum outer radius is at least 1.0 mm and in particular at least 1.25 mm.

It is further preferred that the inner part of the artificial tooth element is formed with an asymmetric shape. In particular, the inner part is formed to be non-rotationally symmetrical. Thereby, an erroneous insertion into the prosthesis base is avoided.

Further, a prosthesis base is provided for producing a prosthesis. The prosthesis base comprises a plurality of cavities, each for receiving one artificial tooth element, as described above and developed in an advantageous manner. The inner surface of the cavities preferably has an at least partly defined surface roughness. In particular, the corresponding inner surface has a size such that it forms at least the bonding surface and thus a defined surface roughness exists in the region of the bonding surface. Preferably, the entire inner surface has a defined surface roughness. It is preferred that the surface roughness of the inner surface of the cavities has an arithmetic average roughness value Rₐ of >0 to 30 μm. An arithmetic average roughness value Rₐ of >0 to 10 μm, particularly 0.5 to 5 μm, is particularly preferred, with 1 to 4 μm being more preferred, and 2 to 3 μm being most preferred.

The arithmetic average roughness value Rₐ of the inner side of the cavity may preferably have values as described above with respect to the surface of the inner part of the artificial tooth element.

In particular for a further improvement of the adhesive bond between the artificial tooth element and the prosthesis it is preferred that the arithmetic average roughness value of the upper side of the cavity is ±50% of the arithmetic average roughness value of the surface of the inner part of the artificial tooth element.

Here, the individual cavities are preferably formed with respect to a direction of insertion of the corresponding artificial tooth element into the prosthesis base such that the cavities are free from undercuts. Thereby, a simple arrangement of the artificial tooth elements in the corresponding prosthesis base is possible.

The individual cavities of the prosthesis base are preferably formed to be complementary to the respective inner part of the artificial tooth element to be inserted correspondingly. Thereby, a gap of a constant width is formed between a respective cavity and the inner part of the associated tooth element. This ensures a safe fastening of the artificial tooth element in the prosthesis base. Moreover, the congruence between the real prosthesis and the planned virtual prosthesis is thus very high, so that the end use has to do little reworking, if any. In particular the occlusion plane and function correspond very precisely to the plan and only have to be reworked a little, if at all.

In a particularly preferred development of the prosthesis base, the cavity has a minimum inner radius equal to or larger than the minimum outer radius of the inner part of the artificial tooth element. If the inner part of the artificial tooth element has an outer radius of e.g. a minimum 0.6 mm or more, the cavity exclusively has radii that are at least 0.6 mm or larger. This has the advantage that, when forming the cavities, tools such as a milling tool can be used, whose milling head or the like has a corresponding working radius. With a radius of at least 0.6 mm, a milling head with a diameter of 1.2 mm can thus be used. For the forming of smaller radii, a smaller milling head would have to be used. Using small milling heads or corresponding tools prolongs the time for forming a cavity and results in a shorter service life of the tool. Therefore, it is further preferred that the minimum inner radius of the cavity is in particular equal to or greater than 1.0 mm and, as is particularly preferred, equal to or greater than 1.25 mm.

In particular when asymmetric, specifically non-rotationally symmetrically shaped artificial tooth elements are used, the cavities are also formed asymmetrically, specifically non-rotationally symmetrically, in a preferred embodiment. This has the essential advantage that a clear association between the respective artificial tooth element and the corresponding cavity, as well as a clear positional definition of the corresponding tooth element in the cavity are defined in a clear and unambiguous manner.

Therefor, it is particularly preferred that the cavities each have a different shape so that an unambiguous association between the artificial tooth element and the cavity exists. As such, an erroneous insertion is excluded.

Moreover, it is preferred that the cavities are formed, in particular have a depth such that an inserted artificial tooth element has a defined tooth height.

Further, it is particularly preferred, especially also for aesthetic reasons that the virtual gingiva line of the artificial tooth element coincides at least partly, in particular completely, with the cavity edge in the inserted state and the two edges overlap, in particular completely.

A particularly suitable method for manufacturing a prosthesis base, as well as artificial tooth elements is described in WO 2018/036853.

The disclosure will be explained in more detail hereinafter with reference to a preferred embodiment and to the accompanying drawings.

### BRIEF DESCRIPTION OF THE DRAWINGS

In the Figures:

FIG. 1 is a schematic perspective side view of an artificial tooth element of the present disclosure,

FIG. 2 is a schematic perspective rear view of an artificial tooth element of the present disclosure,

FIG. 3 is a schematic top plan view on a cavity in a prosthesis base,

FIG. 4 is a schematic sectional view of a tooth element inserted into the cavity base, and

FIG. 5 is a perspective view of a prosthesis base with some artificial tooth elements inserted.

### DETAILED DESCRIPTION OF THE PREFERRED EMBODIMENT

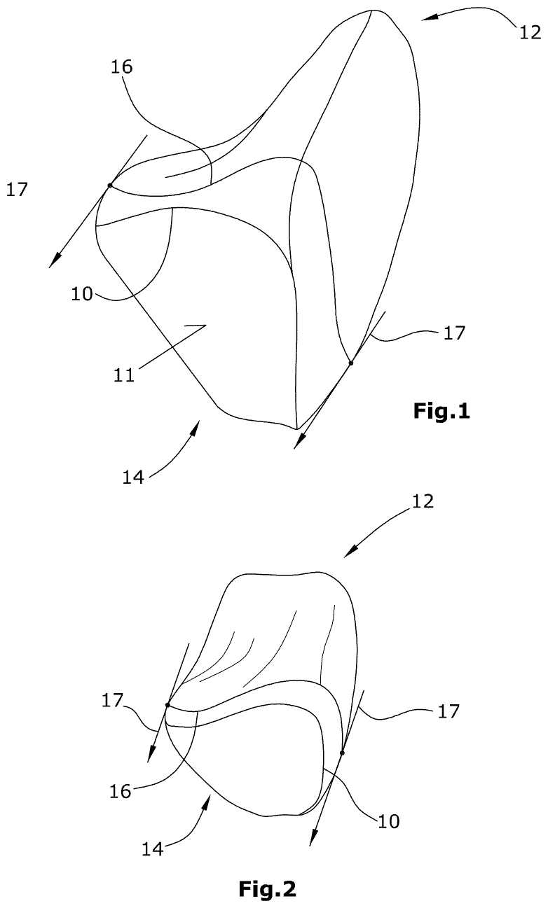

The virtual gingiva line 10 is illustrated in the example of a tooth element shown in FIGS. 1 and 2, the tooth element being an incisor. The artificial tooth element illustrated as an example has an inner part 12 and an outer part 14. The outer part 12 is separated from the inner part 14 by the virtual gingiva line 10. When the artificial tooth element has been inserted into the prosthesis base, the outer part 12 is arranged or visible outside the prosthesis base. In the inserted state, the inner part 14 is arranged inside the prosthesis base and as such is invisible. A surface 11 defined by the inner part 14, which extends to the virtual gingiva line 10, has the defined surface roughness of the present disclosure.

The virtual gingiva line is in the undercut-free region. The undercut-free region is defined by a line 16. Here, the line 16 defines the border of the undercut-free region in the direction of placement or insertion. In FIG. 1, no undercut exists below the line 16 with respect to the direction of insertion (arrows 17) into the prosthesis base. Above the line 16, an undercut is made.

The line 16, which is arranged within the outer part 12 with respect to the virtual gingiva line 10 and is spaced from the virtual gingiva line 10, can further define a border of the surface 11 having a defined roughness. In a preferred development, the surface 11 having a defined roughness thus not only includes the surface in the region of the inner part 14, but also extends into the outer part towards or up to the line 16.

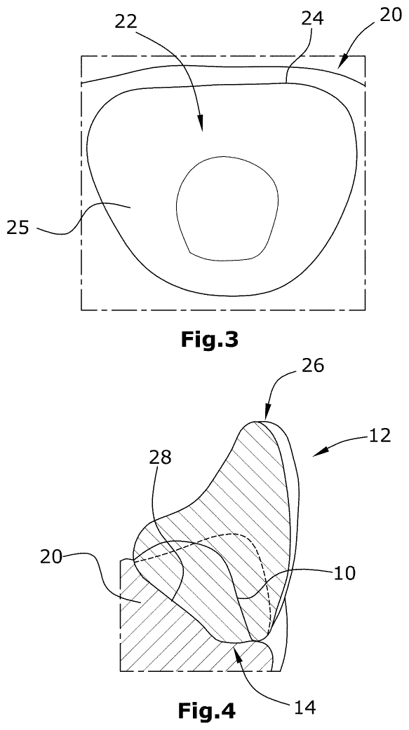

A prosthesis base 20 (FIG. 3) includes a cavity 22. The same is defined by a cavity edge 24. An inner surface 25 of the cavity 22 preferably extends up to the cavity edge 24. The inner surface 25 has the defines surface roughness of the present disclosure.

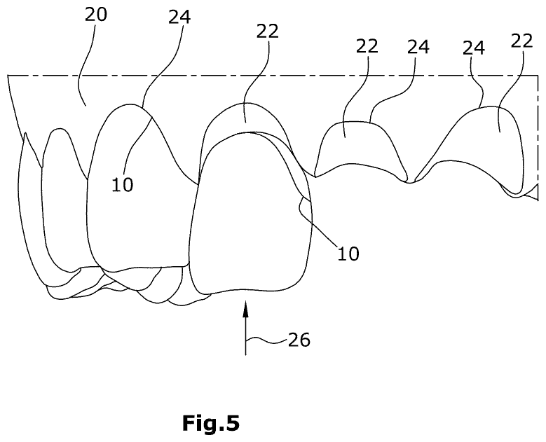

Since it is particularly preferred that the inner part 14 of the tooth element has no undercuts in a direction of insertion 26 (FIG. 4) of the tooth elements into the cavities 22, a simple mounting or fastening, i.e. in particular insertion and gluing, into the cavities 22 is possible. Here, the cavities 22 also have no undercuts in the corresponding direction of insertion. The direction of insertion 26 extends substantially perpendicularly to the prosthesis base. With the prosthesis arranged in the oral cavity of a patient, the direction of insertion would extend substantially perpendicularly.

The cavity 22 is formed to be complementary to the inner part, so that an exact positional definition of the tooth element in the cavity 22 is given. By a complementary design of the inner part 14 and the cavity 22, it is further possible to form—if necessary—a bonding gap 28 (FIG. 4) having a constant width across its entire surface. As such, the volume of the bonding gap and thus the required amount of adhesive are known exactly.

In FIG. 4, in which the tooth element and also the prosthesis base 22 are illustrated in section, the virtual gingiva line 10 is illustrated in addition. Here, with respect to the sectional surface of the tooth element, the part of the virtual gingiva line 10 shown as a solid line extends in front of the drawing plane and the part illustrated in broken lines extend behind the drawing plane.

For a complete manufacture of a prosthesis, a plurality of cavities is provided in the prosthesis bas 20 (FIG. 5). For example, first, a defined amount of adhesive is placed in the individual cavities, and the corresponding tooth elements are thereafter inserted into the cavities 22 in the direction of insertion. With inserted tooth elements, the cavity edge 24 and the virtual gingiva line 10 preferably overlap. Due to the defined surface roughness of the surface 11 of the inner part 14 of the tooth element, as well as due to the defined roughness of the surface 25 of the cavity 22, it is possible to make a stable and very strong bond.

1. An artificial tooth element or direct insertion into a cavity of a prosthesis base, comprising
an outer part visible in the inserted state, and
an inner part not visible in the inserted state,
wherein
the inner part comprises a defined surface roughness at least in part.

2. The artificial tooth element according to claim 1, wherein the inner part has a defined surface roughness in the region of a bonding surface.

3. The artificial tooth element according to claim 1, the inner part has a defined surface roughness across the entire surface.

4. The artificial tooth element according to claim 1, wherein the surface roughness has an arithmetic average roughness value Rₐ of >0 to 30 μm.

5. A prosthesis with a prosthesis base having a plurality of cavities in each of which an artificial tooth element according to claim 1 is inserted.

6. The prosthesis according to claim 5, the cavities have an inner surface which at least in part has a defined surface roughness.

7. The prosthesis according to claim 6, wherein the inner surface has a defined surface roughness in the region of a bonding surface.

8. The prosthesis according to claim 6, wherein the entire inner surface has a defined surface roughness.

9. The prosthesis according to 5, wherein the surface roughness of the inner side has an arithmetic average roughness value Rₐ of >0 to 30 μm.

10. The prosthesis according to claim 5, wherein the cavities are free from undercuts with respect to a direction of insertion in which the tooth element is inserted into the prosthesis base.

11. The prosthesis according to claim 5, wherein the cavities are formed complementary to the inner parts of the respective artificial tooth element so that a gap of in particular constant width is formed between the cavities and the inner part of the associated tooth elements.

12. The prosthesis according to claim 5, wherein the cavities are formed asymmetrically, and/or all cavities have different shapes so that an unambiguous association between an artificial tooth element and a cavity exists.

13. The prosthesis according to claim 5, wherein the cavities are formed such that an inserted artificial tooth element has a defined tooth height.

14. The prosthesis according to claim 5, wherein the cavities have a minimum inner radius that is equal to or greater than the minimum outer radius of the inner part of the artificial tooth element to be inserted into the cavity.

15. The artificial tooth element according to claim 4, wherein the surface roughness has an arithmetic average roughness value Rₐ of >0 to 10 μm.

16. The artificial tooth element according to claim 15, wherein the surface roughness has an arithmetic average roughness value Rₐ of about 0.5 to about 5 μm.

17. The artificial tooth element according to claim 16, wherein the surface roughness has an arithmetic average roughness value Rₐ of about 1 to about 4 μm.

18. The artificial tooth element according to claim 17, wherein the surface roughness has an arithmetic average roughness value Rₐ of about 2 to 3 about μm.
